(19) United States
(12) Patent Application Publication
(10) Pub. No.: US 2006/0243165 A1
(43) Pub. Date: Nov. 2, 2006

(54) Colorant suspensions

(75) Inventors: Thomas Luthge, Hanau (DE); Gerd Tauber, Seligenstadt (DE); Ralph McIntosh, Hanau (DE); Heinz Zoch, Maintal (DE); Werner Kalbitz, Rodenbach (DE); Jutta Zimmermann, Alzenau (DE); Christian Sieblist, Partenstein (DE); Stephan Ludtke, Maintal (DE)

Correspondence Address: FITCH, EVEN, TABIN & FLANNERY, P. O. BOX 65973, WASHINGTON, DC, 20035, US

(73) Assignee: Degussa AG, Dusseldorf (DE)

(21) Appl. No.: 11/362,758

(22) Filed: Feb. 28, 2006

(30) Foreign Application Priority Data
Mar. 1, 2005 (DE) 10 2005 009 321.3

(51) Int. Cl. C09B 27/00

(52) U.S. Cl. 106/496

(57) ABSTRACT

The invention is directed to a suspension containing: (a) at least one water-insoluble colorant,
(b) at least one heterocyclic compound of the general formula 1 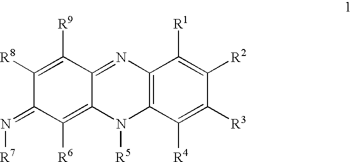 and (c) water and/or a mono- or polyhydric alcohol. The aqueous suspension is produced when the water-insoluble colorant and the heterocyclic compound of the formula 1 are dispersed in water and/or a mono- or polyhydric alcohol. The suspension is useful for producing waterborne inks, ink jet inks, coatings and solventborne printing inks.

### CROSS REFERENCE TO RELATED APPLICATIONS

The present application claims priority to German Application No. 10 2005 009 321.3, filed Mar. 1, 2005, which is incorporated in its entirety herein by reference.

### FIELD OF THE INVENTION

The invention relates to a suspension, to a process for its production and to its use.

### BACKGROUND

Colorants that are insoluble in their respective application medium may be used for the coloration of textiles/fibres (EP 0263412), paper (U.S. Pat. No. 4,366,139), plastics (U.S. Pat. No. 5,760,112, WO 9523038), emulsion paints (U.S. Pat. No. 3,998,652, U.S. Pat. No. 3,841,888) and concrete (WO 01550050), and also for ink jet inks (U.S. Pat. No. 9,911,935). Insoluble colorants may be employed not only for their colour-conferring action but also for other properties, for example for reinforcement, for antistaticizing or as a filler. For example, aqueous suspensions of graphite may be used for the antistaticization of materials such as textiles or in the manufacture of toners (PL 178064, JP 08015895).

Colloidal suspensions of carbon black have been used for colouring textiles, leather or latices and for adjusting the conductivity of plastics, adhesives, silicones and the like. These suspensions have also been used in the manufacture of coatings, solvent-borne printing inks and directly as water-borne inks, for example for ink jet printers (U.S. Pat. No 5,085,698, U.S. Pat. No. 5,320,668).

Suspensions of insoluble colorants may be produced using azo compounds that act as wetting agents without the addition of further wetting agents (U.S. Pat. No.9,911,935). Water-soluble wetting agents, for example acrylic resins (U.S. Pat. No. 5,609,671) or ethoxylates (DE 19824947 A1) may also be used to produce aqueous suspensions of carbon black.

Disadvantages of existing wetter-stabilized suspensions of carbon black are an excessively high zeta potential and a low surface tension when nonionic surfactants are used. When anionic surfactants are used, an excessive wetting of the paper may occur due to strong interactions with the similarly anionic paper coating, and may lead to low optical densities or colour strengths.

One disadvantage of using azo compounds for stabilizing colorants that are insoluble in their application medium is the appearance of aromatic amines as degradation products. A large number of these primary aromatic amines are suspected of being carcinogenic. Furthermore, azo compounds can be oxidation sensitive, which can lead to instabilities in use. A further disadvantage of using azo compounds is the high fraction of inorganic salts such as sodium chloride or sodium sulphate that is inevitably generated in the course of the synthesis of the azo compounds. Even very low concentrations of inorganic salts lead to a severe and irreversible increase in viscosity.

### DESCRIPTION OF THE INVENTION

The objective of the present invention is to provide a suspension that: exhibits improved stability and compatibility in particular application systems; possesses high optical densities or colour strengths on support materials, for example paper, latex, plastic or textiles; and has a low zeta potential and a high surface tension. The invention provides a suspension which contains: (a) at least one water-insoluble colorant; and (b) at least one heterocyclic compound of the general formula 1: 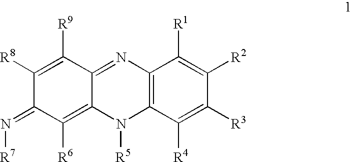
where R¹—R⁹ are the same or different and consist of hydrogen, hydrophilic or hydrophobic groups, acceptor or donor substituents or aliphatic, aromatic or heteroaromatic, acyclic or cyclic systems having acceptor, donor, hydrophilic or hydrophobic groups, and (c) water and/or a mono- or polyhydric alcohol.

The mono- or polyhydric alcohol may be butanol, ethanol, butylglycol, ethoxypropanol, ethylene glycol, glycerol, pentanediol, propanediol or a polyol. The aliphatic, aromatic or heteroaromatic, cyclic or acyclic systems may contain further radicals, for example hydrophilic or hydrophobic, charged or uncharged groups.

The suspension of the invention may be colloidal. Colloidal refers to the uniform distribution of particles of 10 nm-10 μm in diameter in a suspension medium. For use in inks, a low viscosity is advantageous, depending on the printing process, to obtain the desired printing properties, for example crispness. A low zeta potential, which describes the charge state of the particles in the suspension, is a measure of good suspension stability. A high surface tension has an influence on droplet formation, for example a positive influence in the ink jet process. A high degree of dispersion is of significant importance for good stability in storage, for good colour properties in use and for preventing nozzle clogging in the ink jet process specifically.

Useful water-insoluble colorants include organic and inorganic pigments, for example carbon materials, white pigments and colour pigments, such as yellow pigments, cyan pigments, magenta pigments or green pigments.

Carbon black is a useful carbon material. Useful carbon blacks include furnace black, gas black, channel black, lamp black, thermal black, acetylene black, plasma black, inversion black, known from DE 195 21 565, Si-containing blacks, known from WO 98/45361 or DE 19613796, or metal-containing carbon blacks, known from WO 98/42778, arc carbons and carbon materials which are by-products of chemical manufacturing operations. The carbon material may be activated by upstream reactions. Carbon materials used as a reinforcing filler in rubber mixtures can be used. Pigment grade carbon blacks can also be used.

Useful carbon materials also include conductive carbon material, carbon material for UV stabilization, carbon material useful as a filler in systems other than rubber, for example in bitumen or plastic, or carbon material useful as a reducing agent in metallurgy. In addition, useful carbon materials include graphite powder, graphite fibres, bitumen, carbon fibres, carbon fibrils, carbon nanotubes, carbon fabrics, carbon aerogels, glassy carbon products and activated carbon.

The gas black may have a volatile fraction (950° C.) of <25% by weight. The lamp black may have a BET surface area in the range from 80 to 350 m²/g. The lamp black may have a primary particle size, measured according to ASTM D3849, in the range from 8 to 40 nm and preferably in the range from 13 to 30 nm and more preferably of 13-20 nm. The lamp black may also have an oil requirement, measured according to DINISO 787/5, in the range from 250 to 1000 g/100 g. The lamp black may also be a mixture of various lamp blacks. Useful lamp blacks include for example Farbruβ FW 200, Farbruβ FW 2, Farbruβ FW 2 V, Farbruβ FW 1, Farbruβ FW 18, Farbruβ S 170, Farbruβ S 160, Spezialruβ 6, Spezialruβ 5, Spezialruβ 4, Spezialruβ 4A, NIPex 150, NIPex 160 IQ, NIPex 170 IQ, NIPex 180 IQ, Printex U, Printex V, Printex 140 U or Printex 140 V from Degussa AG.

Useful carbon blacks further include Elftex 570, Elftex 430, Elftex 125, Regal 350R, Raven 1080U or Raven 1255 from Cabot or Conductex 975 or Conductex SC from Columbien. The furnace black may have a volatile content (950° C.) of <5% by weight. The furnace black may have a BET surface area in the range from 20 to 350 m²/g. The furnace black may have a primary particle size of <70 nm. The furnace black may have a DBP in the range from 35 to 450 ml/100 g. The furnace black may also be a mixture of various furnace blacks. The furnace black may have a pH between 2 and 10.5.

Useful furnace blacks include for example Printex 60, Printex L, Printex L6, Printex 300, Printex 25, Spezialschwarz 100, Spezialschwarz 250, Spezialschwarz 350 and Spezialschwarz 550 from Degussa AG. A useful lamp black is for example Flammruβ 101 from Degussa AG.

Useful chromatic pigments include titanium dioxide, chalk, calcium carbonate, Pigment Yellow 128, Pigment Yellow 180, Pigment Yellow 155, Pigment Yellow 97, Pigment Yellow 120, Pigment Yellow 15, Pigment Yellow 101, Pigment Yellow 108, Pigment Yellow 24, Pigment Yellow 151, Pigment Yellow, Pigment Violet 19, Pigment Violet 3, Pigment Red 122, Pigment Red 57:1, Pigment Red 184, Pigment Blue 15:3, Pigment Blue 29, Pigment Blue 27, Pigment Blue 61, Pigment Black 6, Pigment Black 1, Pigment Black 11, Pigment Black 7, Pigment Black 10, Pigment Black 8, Pigment Black 9. 83.

The heterocyclic compound of the general formula 1 may be singly or multiply present in the heterocyclic compound of the general formula 1. The substituents R¹-R⁹ may be the same or different and may be unsubstituted or substituted, aliphatic or aromatic substituents such as phenyl or naphthyl or heteroaromatic substituents, for example pyrrolyl, pyridinyl, furyl or puryl, acceptor substituents, such as —COOR¹⁰, —CO—R¹⁰, —CN, —SO₂R¹⁰, —SO₂OR¹⁰, where R¹⁰═H, alkali metal cation, ammonium, alkyl, aryl or functionalized alkyl or aryl, for example ω-carboxyalkyl, HSO₃—CₓH_{y}—, H₂N—CₓH_{y}— or H₂N—SO₂—CₓH_{y}— (x=1-20, y=1-45), donor substituents, such as alkyl groups, aryl groups, OR¹¹, N(R¹¹)₂, SR¹¹, P(R¹¹)₂, where R¹¹═H, alkyl, aryl or functionalized alkyl or aryl, or oligomers or polymers of the form —(O—R¹²)_{y}—OR¹³, where R¹²=functionalized or non-functionalized, branched or unbranched, saturated or unsaturated, aliphatic, aromatic or mixedly aliphatic-aromatic two-valent hydrocarbyl group and R¹³═H, alkyl or aryl.

The heterocyclic compound of formula 1 may have a positive or negative charge or be uncharged. In the case of an electrically charged heterocyclic compound, the charge may be wholly or partly neutralized by a counter-ion X bearing the appropriate opposite charge. The counter-ion X may be a positively charged metal ion, such as an alkali metal ion, an alkaline earth metal ion or an ammonium ion N(R¹⁴)₄⁺, where each R¹⁴ is the same or different and is selected from H, alkyl, aryl, functionalized alkyl or aryl, for example ω-carboxyalkyl, HSO₃—CₓH_{y}—, H₂N—CₓH_{y}—, H₂N—SO₂—CₓH_{y}— (x=1-20, y=1-45), monomers, dimers, trimers, oligomers or polymers of the form —(O—R¹²)_{y}—OR¹³.

A negatively charged counter-ion X may be halide, such as F⁻, Cl⁻, Br⁻ or I⁻, sulphate, hydrogensulphate, carbonate, bicarbonate, phosphate, hydrogenphosphate, bromate, bromite, chlorite, hypochlorite, chlorate, perchlorate, tetrafluoro-borate or tetraphenylborate. The heterocyclic compound of the formula 1 may be wholly or partly present as a free-radical salt. Useful heterocyclic compounds of the general formula 1 include for example:

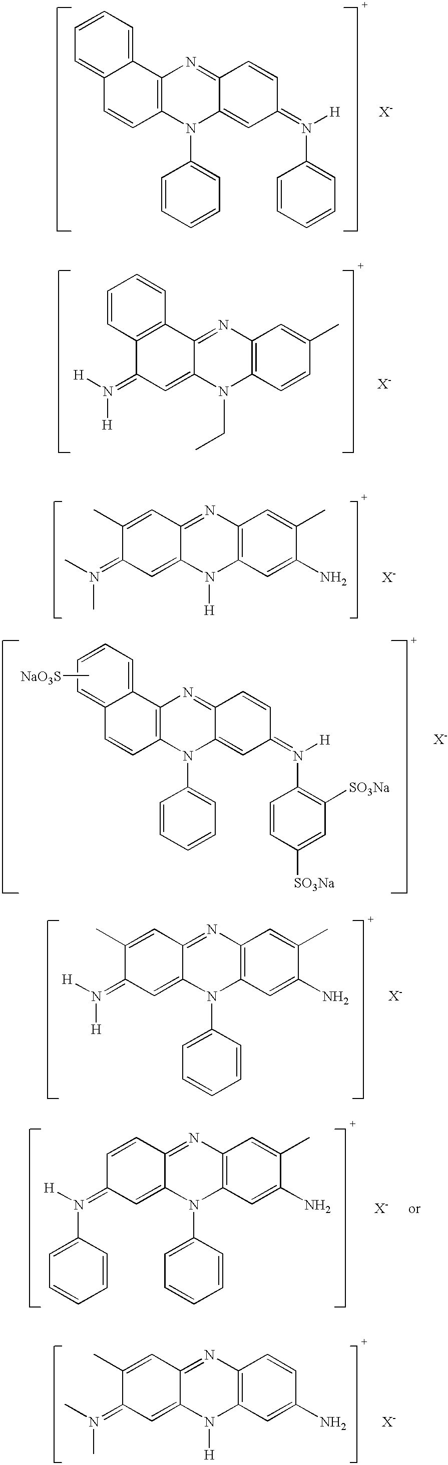

The fraction of heterocyclic compound of the formula 1 in the suspension of the present invention may be below 5% by weight, preferably below 3% by weight. The suspension of the present invention may also be free of wetting agent.

The suspension of the present invention may contain a biocide. The biocide may be included in amounts of 0.01-1.0% by weight. Useful biocides include isothiozolinone derivatives, formaldehyde donors or combination products of the two. Useful biocides include for example Parmetol from Schülke & Mayr, Ebotec from Bode Chemie, Acticide from Thor Chemie, Mergal from Troy or Proxel from Zeneca.

Wetting agents (wetters) may further be included in amounts of 0.01-1% by weight and preferably of 0.4-0.6% by weight, based on the total suspension. Useful wetting agents include compounds such as fatty alcohol ethoxylates, polyacrylic acid and/or derivatives thereof, copolymers containing acrylic acid and/or acrylic acid derivatives and/or styrenes and/or styrene derivatives and/or polyethers, ligninsulphonate, alkylbenzenesulphonate, naphthalenesul-phonic acid derivatives or copolymers containing maleic anhydride and/or maleic acid derivatives. The copolymers may be random or alternating block or graft copolymers. For example, Joncryl 678, Joncryl 680, Joncryl 682 or Joncryl 690 from Johnson Polymer B.V. may be used as a dispersion-augmenting additive.

One preferred embodiment may utilize fully ammonium- or alkali metal hydroxide-neutralized forms, especially NaOH-neutralized forms, of the styrene-acrylic acid copolymers as a dispersion-augmenting additive. Other types of wetting agents may likewise be used for producing the suspension of the present invention.

The suspension of the present invention may further include additives, such as ketones, for example methyl ethyl ketone, methyl isobutyl ketone or diisobutyl ketone, alcohols, for example 1,5-pentanediol, glycols, for example dipropylene glycol, heterocycles, for example 2-pyrrolidone, or glycerol.

The fraction of additives in the aqueous suspension of the present invention may be below 25% by weight and preferably below 15% by weight.

The present invention further provides a process for producing the suspension of the present invention, this process being characterized in that the water-insoluble colorant and the heterocyclic compound of the general formula 1 are dispersed in water and/or a mono- or polyhydric alcohol.

The dispersing may be effected using a bead mill, an ultrasonicator, a high pressure homogenizer, a micro-fluidizer, a dissolver, a rotor-stator assembly (Ultra-Turrax) or a comparable assembly. Following the dispersing, the aqueous suspension may be purified by centrifugation and/or filtration.

The suspension of the present invention may be used in water-borne inks, ink jet inks, coatings and solvent-borne printing inks. The suspension of the present invention may also be used for reinforcement, coloration, conductivity rendering, for example antistaticization or conductivization, and UV stabilization of plastics (for example polyacrylate dispersions: homo- and copolymers of acrylic and methacrylic esters, acrylic esters and styrene, acrylic esters and vinyl acetate, vinyl acetate and maleic esters; latex dispersions: butadiene, styrene and acrylonitrile (styrene-butadiene and acrylonitrile-butadiene), polychloroprene, acrylonitrile-butadiene-styrene (ABS), acrylonitrile-butadiene; poly-urethane dispersions: polyurethane-acrylate dispersions, epoxy-polyurethane and polyurethane-epoxy-acrylate dispersions; polyvinyl acetate: homo- and copolymers, vinyl acetate-ethylene copolymers, vinyl acetate-ethylene-acrylate ter-polymer, vinyl acetate-acrylate copolymer, vinyl acetate-versatate copolymers, ethylene-vinyl chloride-, vinyl acetate-maleate; epoxy resins: self-crosslinking, oxidatively or UV-curing, with and without plasticizer), textiles, leather, adhesives, latices, silicones, concrete, building materials, paper, fibres, earth, wood, waterborne inks, ink jet inks, coatings and solventborne printing inks. In addiiton, the suspension may be used in architectural coatings, printing inks, polymer dispersions or adhesives. The present invention further provides inks and plastics characterized by the presence of the suspension described herein.

One advantage of the suspension according to the present invention is the use of heterocyclic compounds that are devoid of azo groups. Further advantages of the present invention's suspension of colorants that are insoluble in their application medium are the high optical densities, the low zeta potential, the high surface tension, the good stabilities in storage and a high degree of dispersion.

### EXAMPLES

Measurement of depth of shade
Measuring instrument Datacolor Spectraflash 600 PLUS
Measuring geometry d/8°
Illuminant D 65/10°; with UV filter
Other particulars Measuring opening 30 mm without inclusion of lustre
Evaluating software BCSWin Version 2.2 2000 (BASF Color System for Windows)

The instrument was calibrated in accordance with the manufacturer's instructions before measurement. The sample is measured through the film (film side top).
Measurement of colour strength
Measuring instrument Datacolor Spectraflash 600 PLUS Measuring geometry d/8°
Illuminant D 65/10°; with UV filter
Other particulars Measuring opening 30 mm without inclusion of lustre
Evaluating software BCSWin Version 2.2 2000 (BASF Color System for Windows)

The instrument was calibrated in accordance with the manufacturer's instructions before measurement. The sample is measured through the film (film side top).

Measurement of Viscosity

A Brookfield DV II+ with an S93 cross-arm spindle at 30 rpm is used by adjusting the instrument such that the spindle is completely immersed in the liquid, floating therein about 1 cm above the bottom of the vessel. The measuring temperature is 23° C. Measurement is continued until the instrument has settled down on one value.

Description of Examination Under Optical Microscope

A drop of the dispersion to be assessed is placed on a microscope slide and covered with a cover slip. Pressure is then carefully exerted on the drop, using the thumb for example, until a brownish transparent layer has formed. Care must be taken to avoid rubbing or the exertion of any other shearing forces. The microscope slide is placed under a transmission light microscope giving a magnification of at least 400 fold (for example a Nikon Optiphot). As well as the uniformity of the particle sizes it is possible to judge whether a dispersion is present or a flocculated system. In a dispersion, the particles move about completely uncoordinatedly owing to Brownian motion. A flocculated dispersion exhibits directional streaming.

### Examples 1-3

The amount of water needed (Table 1) is weighed into the dispersing vessel (a plastic beaker). Dispersing assistant (Table 1) or nigrosine (Table 1) is weighed into the beaker and completely dissolved in water. The carbon black (Table 1) is weighed out and added to the solution. The carbon black is stirred into the solution with a spatula until completely wetted. A Hielscher UIP 500 ultrasonicator is used for 1 minute to disperse the carbon black. The dispersion is examined under the optical microscope.

Nigrosine is a dye, a product of the reaction of nitrobenzene and aniline in the presence of iron(II) chloride and hydrochloric acid, comprising a complex mixture of phenazine dyes of the general formula 1. Thin layer chromatography indicates the presence of a large number of compounds likewise present in induline, particularly induline 6B of the formula

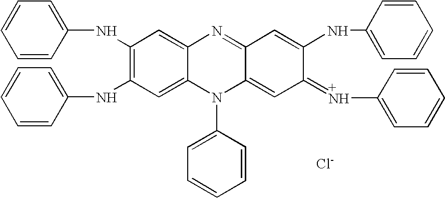

Unlike induline, the dye consists mainly of phenazines of higher molecular weights. It is possible to distinguish between water-, ethanol- and fat-soluble nigrosines. The Nigrosine WLF Uncut Powder used in the examples is water-soluble.

TABLE 1
Preparation of suspensions

| | Inventive | Comparative | Inventive | Comparative | Inventive | Comparative |
|---|---|---|---|---|---|---|
| | Example 1 | Example 1 | Example 2 | Example 2 | Example 3 | Example 3 |
| Water- | Printex U | Printex U | Printex 140 | Printex 140 | Farbruβ 160 | Farbruβ 160 |
| insoluble | 21 g | 21 g | 35 g | 35 g | 20 g | 20 g |
| colorant | | | | | | |
| Heterocyclic | Nigrosine* | — | Nigrosine* | — | Nigrosine* | — |
| compound | 0.5 g | | 0.5 g | | 0.5 g | |
| Dispersing | — | Tamol NN | — | Tamol NN | — | Tamol NN |
| assistant* | | 8906* | | 8906* | | 8906* |
| | | 3 g | | 4.5 g | | 3 g |
| | | | | | | Arkopal |
| | | | | | | N130* |
| | | | | | | 10 g |
| Water | to make up | to make up | to make up | to make up | to make up | to make up |
| | to 100 g | to 100 g | to 100 g | to 100 g | to 100 g | to 100 g |

*Tamol NN 8906 BASF/Ludwigshafen
Arkopal N 130 Clariant/Frankfurt
Nigrosine WLF Uncut Powder Bayer

### Examples 4-6

80 g of polymer dispersion are weighed into a vessel and 20 g of the suspension are added. Using a metallic spatula, a homogeneous mixture is prepared by careful stirring (Table 2). Of this mixture, a film 45 μm in thickness is drawn onto photographic cardboard using an Erichson “K Comfort Coater”. The blackness of this film is determined using a colour-measuring instrument. The measured absolute depth of shade is depicted in Table 2.

TABLE 2

| | Inventive | Comparative | Inventive | Comparative | Inventive | Comparative |
|---|---|---|---|---|---|---|
| Absolute depth of | Example | Example | Example | Example | Example | Example |
| shade | 4 a-c | 4 a-c | 5 a-c | 5 a-c | 6 a-c | 6 a-c |
| Suspension | Inventive | Comparative | Inventive | Comparative | Inventive | Comparative |
| | Example 1 | Example 1 | Example 2 | Example 2 | Example 3 | Example 3 |
| Polymer | | | | | | |
| dispersion* | | | | | | |
| a)Primal E 941 P* | 195 | 194 | 203 | 183 | 184 | 176 |
| b)Perbunan X 120* | 202 | 201 | 218 | 214 | 205 | 200 |
| c)Baystal S 44R* | 186 | 167 | 199 | 187 | 176 | 174 |

*Primal E 941 P: acrylate emulsion from Rohm & Haas/Frankfurt
Perbunan X 1120: butadiene-acrylonitrile copolymer from Polymerlatex/Marl
Baystal S 44R: styrene-butadiene copolymer from Polymerlatex/Marl

All film drawdowns prepared using the inventive suspensions gave higher blackness numbers (absolute depths of shade), suggesting better compatibility between suspension and polymer dispersion.

### Examples 7-10

80 g of polymer dispersion are weighed into a vessel and 20 g of the suspension of Inventive Example 1 or Comparative Example 1 are added. Using a metallic spatula, a homogeneous mixture is prepared by careful stirring.

49.5 g of the white dispersion (Isposan perfect from Sto AG) are weighed into a vessel and 0.5 g of the suspension-coloured polymer dispersion is added. Using a metallic spatula, a homogeneous mixture is prepared by careful stirring. The mixture is homogenized for 30 seconds in a Hauschild turbomixer at 300 rpm. A thin layer of this mixture is spread by means of a 200 μm doctor onto an acetate foil and air dried to form a film. Table 3 shows the measured absolute colour strength.

TABLE 3

| Absolute | | | | | | | | |
|---|---|---|---|---|---|---|---|---|
| colour | Inventive | Comparative | Inventive | Comparative | Inventive | Comparative | Inventive | Comparative |
| strength | Example 7 | Example 7 | Example 8 | Example 8 | Example 9 | Example 9 | Example 10 | Example 10 |
| Polymer | Perbunan | Perbunan | Baystal | Baystal S | Plextol DV | Plextol DV | Perbunan- | Perbunan- |
| dispersion* | X 2890* | X 2890* | S 44R* | 44R* | 455* | 455* | N-Latex | N-Latex |
| | | | | | | | VT-LA* | VT-LA* |
| Inventive | 47 | | 45 | | 44 | | 45 | |
| Example 1 | | | | | | | | |
| suspension | | | | | | | | |
| Comparative | | 37 | | 39 | | 38 | | 37 |
| Example 1 | | | | | | | | |
| suspension | | | | | | | | |

*Perbunan X2890 butadiene-acrylonitrile copolymer from Polymerlatex/Marl
Baystal S 44R styrene-butadiene copolymer from Polymerlatex/Marl
Plextol DV 455 acrylic polymer from Polymerlatex/Marl
Perbunan-N-Latex VT-LA carboxylated butadiene-acrylonitrile copolymer from Polymerlatex/Marl

All the film drawdowns prepared using the inventive suspension give higher colour strength values, which suggests better compatibility of the suspension in the composition of matter (polymer dispersion and white dispersion).

### Example 11

70 g of polymer dispersion are weighed into a vessel and 30 g of the suspension of Inventive Example 1 or Comparative Example 1 are added. Using a metallic spatula, a homogeneous mixture is prepared by careful stirring. 50 ml of the homogeneous mixture are transferred into a glass beaker to measure the viscosity. Table 4 shows the viscosity.

TABLE 4

| | | | | Com- |
|---|---|---|---|---|
| | Inventive | | Inventive | parative |
| | Example | Comparative | Example | Example |
| | 11 | Example 11 | 11 | 11 |
| | a-e | a-e | a-e | a-e |
| Polymer dispersion* | measured at once | | measured after | |
| | | | 30 minutes | |
| a) Primal E 941 P* | 50 | 46 | 45 | 214 |
| b) Perbunan X 2890* | 31 | 47 | 31 | 194 |
| c) Baystal S 44R* | 21 | 19 | 21 | 97 |
| d) Plextol DV 455* | 52 | 65 | 52 | 182 |
| e) Perbunan - N - | 31 | 28 | | 103 |
| Latex VT-LA* | | | | |

*Primal E 941 P acrylate emulsion from Rohm & Haas/Frankfurt
Perbunan X 2890 butadiene-acrylonitrile copolymer from Polymerlatex/Marl
Baystal S 44R styrene-butadiene copolymer from Polymerlatex/Marl
Plextol DV 455 acrylic polymer from Polymerlatex/Marl
Perbunan - N - Latex VT-LA carboxylated butadiene-acrylonitrile copolymer from Polymerlatex/Marl

None of the polymer dispersions prepared using the inventive suspension changes significantly in viscosity, if at all, whereas with the comparative examples a pronounced increase in the viscosity is observed after just 30 minutes. So the suspension and the polymer dispersion are compatible in the case of the inventive suspension but not in the case of the comparative examples.

What is claimed is:

1. A suspension comprising:
(a) at least one water-insoluble colorant;
(b) at least one heterocyclic compound of the general formula 1 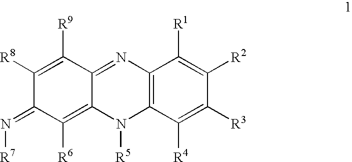
wherein R¹—R⁹ are the same or different and are selected from the group consisting of: hydrogen; hydrophilic or hydrophobic groups; acceptor or donor substituents; and aliphatic, aromatic or heteroaromatic, acyclic or cyclic systems having acceptor, donor, hydrophilic or hydrophobic groups, and
(c) water and/or a mono- or polyhydric alcohol.

2. The suspension of claim 1, wherein said water-insoluble colorant is an organic or inorganic pigment.

3. The suspension of claim 1, wherein said water-insoluble colorant is carbon black, titanium dioxide, chalk, calcium carbonate, Pigment Yellow 128, Pigment Yellow 180, Pigment Yellow 155, Pigment Yellow 97, Pigment Yellow 120, Pigment Yellow 15, Pigment Yellow 101, Pigment Yellow 108, Pigment Yellow 24, Pigment Yellow 151, Pigment Yellow, Pigment Violet 19, Pigment Violet 3, Pigment Red 122, Pigment Red 57:1, Pigment Red 184, Pigment Blue 15:3, Pigment Blue 29, Pigment Blue 27, Pigment Blue 61, Pigment Black 6, Pigment Black 1, Pigment Black 11, Pigment Black 7, Pigment Black 10, Pigment Black 8 or Pigment Black 9. 83.

4. The suspension of claim 1, characterized in that the general formula 1 is singly or multiply present in the heterocyclic compound and the substituents R¹—R⁹ are the same or different and are selected from the group consisting of: phenyl; naphthyl; heteroaromatic substituents; —COOR¹⁰; —CO—R¹⁰; —CN, —SO₂R¹⁰; —SO₂OR¹⁰; where R¹⁰ in each case is H, alkali metal cation, ammonium, alkyl, aryl or functionalized alkyl or aryl, alkyl groups; aryl groups; OR¹¹; N(R¹¹)₂; SR¹¹; P(R¹¹)₂; where R¹¹ in each case is H, alkyl, aryl or a functionalized alkyl or aryl; and oligomers or polymers of the form —(O—R¹²)_{y}—OR¹³, where R¹² is a functionalized or non-functionalized, branched or unbranched, saturated or unsaturated, aliphatic, aromatic or mixed aliphatic-aromatic two-valent hydrocarbyl group and R¹³ is H, alkyl or aryl.

5. The suspension of claim 1, wherein the fraction of the heterocyclic compound of the formula 1 is <5% by weight.

6. The suspension of claim 1, further comprising one or more biocides, wetting agents or additives.

7. The suspension of claim 6, wherein said wetting agent is selected from the group consisting of: a fatty alcohol ethoxylate; a polyacrylic acid or a derivative thereof; a copolymer containing acrylic acid and/or acrylic acid derivatives and/or styrenes and/or styrene derivatives and/or polyethers; ligninsulphonate; alkylbenzene-sulphonate; naphthalenesulphonic acid derivatives; and a copolymer containing maleic anhydride and/or maleic acid derivatives.

8. The suspension of claim 6, wherein the fraction of wetting agent is between 0.01% and 1% by weight.

9. The suspension of claim 6, wherein the additive is a ketone, an alcohol, a heterocycle, a glycol or glycerol.

10. The suspension of claim 6, wherein the fraction of additive is below 25% by weight.

11. A process for producing the suspension of claim 1, comprising dispersing said water-insoluble colorant and said heterocyclic compound of the formula 1 in water and/or a mono- or polyhydric alcohol.

12. The process of claim 11, wherein said dispersing is effected using a bead mill, an ultrasonicator, a dissolver, a high pressure homogenizer, a microfluidizer, a rotor-stator assembly or a comparable assembly.

13. A method of coloring, antistaticizing and/or UV-stabilizing a product comprising applying the suspension of claim 1 to said product or mixing the suspension of claim 1 into the materials used to form said product, wherein said product is selected from the group consisting of: a plastic, a latice, a textile, leather, an adhesive, a silicone, concrete, a building material, paper, fibre, earth, a waterborne ink, an ink jet ink, a coating and a solvent-borne printing ink.

14. The method of claim 13, wherein said product is a waterborne ink, ink jet ink, or solvent-borne printing ink.

15. The method of claim 13, wherein said product is a plastic, a latice, a textile, leather, an adhesive, a silicone, concrete, a building material, paper, fibre, earth,

16. A product comprising the suspension of claim 1, wherein said product is selected from the group consisting of: a plastic; a latice; a textile; leather; an adhesive; a silicone; concrete; a building material; paper; fibre; earth; a waterborne ink; an ink jet ink; a coating; and a solvent-borne printing ink.

17. The product of claim 16, wherein said product is a water-borne ink; an ink jet ink; or a solvent-borne printing ink.

18. The product of claim 16, wherein said product is a plastic.
